(19) United States
(12) Patent Application Publication
(10) Pub. No.: US 2025/0196346 A1
(43) Pub. Date: Jun. 19, 2025

(54) COOPERATIVE CONTROL METOD FOR MULTI-ROBOT AND DEVICE THEREOF

(71) Applicant: KOREA INSTITUTE OF SCIENCE AND TECHNOLOGY, Seoul (KR)

(72) Inventors: Sona KWAK, Seoul (KR); Dahyun KANG, Seoul (KR); Haeri HWANG, Namyangju-si (KR)

(73) Assignee: KOREA INSTITUTE OF SCIENCE AND TECHNOLOGY, Seoul (KR)

(21) Appl. No.: 18/979,448

(22) Filed: Dec. 12, 2024

(30) Foreign Application Priority Data
Dec. 13, 2023 (KR) 10-2023-0180336

(51) Int. Cl. B25J 9/16; B25J 9/00

(52) U.S. Cl. CPC B25J 9/1661; B25J 9/0084; B25J 9/1697

(57) ABSTRACT

The present disclosure relates to a technology for controlling a robotic product. A cooperation control method of a multi-robot comprises detecting information on a user or information on surroundings of the user using sensors, recognizing an intention or a situational context of the user based on the detected information, selecting a task that a plurality of robots are able to cooperatively perform in response to the recognized intention or situational context of the user, and requesting a service provision to each of the plurality of robots that are able to cooperatively perform the selected task.

### CROSS-REFERENCE TO RELATED APPLICATIONS

This application claims the benefit under 35 USC 119 (a) of Korean Patent Application No. 10-2023-0180336 filed on Dec. 13, 2023, in the Korean Intellectual Property Office, the entire disclosure of which is incorporated herein by reference for all purposes.

### TECHNICAL FIELD

The present disclosure relates to a technology for controlling a robotic product, and more particularly, to a method and device for controlling a multi-robot cooperating with each other to provide a service required by a user.

### BACKGROUND

Robots with various functions are being developed to replace human tasks or provide useful services to humans. However, conventional technologies are primarily aimed at enabling a single robot to perform a given task independently, and thus have limitations in performing tasks for various situations or purposes that are recently required. For example, human-robot interaction based on a single robotic product has limitations in user information and environment information that the robot obtains because a type and number of robots used is one.

To solve this problem, robot control methods for collaboration between humans and robots or multi-robots are being studied. A human-robot collaboration model is a model that collaborates by combining human task intelligence and robot control functions, and is a technology that involves human task intervention due to the limitations of robot intelligence. In addition, collaboration between the multi-robots is a technology that allows robots to perform tasks while independently exchanging information on their surroundings. The prior art document presented below describes a multi-robot system and a multi-robot system control method that allow a specific task to be optimally assigned to a multi-robot considering the task suitability of the robot.

Despite the increasing importance of multi-robot systems for efficiently performing given tasks through cooperative task planning and execution of a plurality of robots, human-robot interactions based on multiple conventional robotic products have limitations in the range of tasks that robots can perform because they mainly use homogeneous robots, and have been limited to providing the original functions of the product. In other words, it is impossible to provide a rich user experience because the robot provides only a single service to the user.

Accordingly, in an environment where multiple heterogeneous robotic products coexist, a technological means is required that can recognize tasks suitable for the user and enable various robotic products to cooperate with each other to provide customized services to the user.

### PRIOR ART DOCUMENT

### Patent Document

Korean Patent No. 10-1408075 entitled “Multi-robot system and multi-robot system control method”

### SUMMARY

The technical problems solved by embodiments of the present disclosure are to resolve the weakness of very little interaction between heterogeneous robotic products because an existing multi-robot system is mainly developed focusing on task allocation of homogeneous robots, to overcome a limitation that services that can be provided by multi-robots are limited to the unique functions of the robots themselves, and to resolve a problem that the user experience is insufficient or deficient due to the limited provision of services.

To solve the above-described technical problems, a cooperation control method of a multi-robot performed by a control device, according to an embodiment of the present disclosure comprises detecting information on a user or information on surroundings of the user using at least one sensor, recognizing an intention or a situational context of the user based on the detected information, selecting a task that a plurality of robots are able to cooperatively perform in response to the recognized intention or situational context of the user, and requesting a service provision to each of the plurality of robots that are able to cooperatively perform the selected task.

The cooperation control method of the multi-robot may further comprise registering at least one unit function that is able to be provided from each of the plurality of robots and pre-generating a cooperative executable task of the plurality of robots from a combination of the registered unit functions.

Recognizing the intention or situational context of the user may comprise receiving additional information related to a prearranged behavior of the user, and selecting a most similar candidate among candidates for the intention or situational context of the user based on the received additional information and the detected information.

Requesting the service provision may comprise identifying a plurality of unit functions matched to the selected task, and instructing each of the plurality of robots capable of performing the identified unit functions to mutually perform the corresponding unit function in time series. Requesting the service provision may further comprise controlling an exchange of information on an execution order and an execution process between the robots.

Furthermore, there is provided a computer readable recording medium on which a program for executing the cooperation control method of the multi-robot described above on a computer is recorded.

To solve the above-described technical problems, a cooperative control device of a multi-robot according to an embodiment of the present disclosure comprises a communication unit configured to receive information on a user or information on surroundings of the user detected using at least one sensor, and a processing unit configured to execute instructions that control a plurality of robots to provide a service necessary for the user, and the processing unit is further configured to execute instructions that recognize an intention or a situational context of the user based on the detected information, select a task that the plurality of robots are able to cooperatively perform in response to the recognized intention or situational context of the user, and request a service provision to each of the plurality of robots that are able to cooperatively perform the selected task.

The processing unit may further execute instructions that register at least one unit function that is able to be provided from each of the plurality of robots and pre-generate a cooperative executable task of the plurality of robots from a combination of the registered unit functions.

The processing unit may recognize the intention or situational context of the user by executing instructions that receive additional information related to a prearranged behavior of the user and select a most similar candidate among candidates for the intention or situational context of the user based on the received additional information and the detected information.

The processing unit may request the service provision by executing instructions that identify a plurality of unit functions matched to the selected task, and instruct each of the plurality of robots capable of performing the identified unit functions to mutually perform the corresponding unit function in time series. The processing unit may further execute instructions that control an exchange of information on an execution order and an execution process between the robots when requesting the service provision.

Embodiments of the present disclosure can facilitate information utilization by acquiring a variety of information from multiple homogeneous and heterogeneous robotic products, can more specifically identify the user's intention and more efficiently recognize the situational context by sharing user information and environment information through communication between robots, and can provide optimal user service and a rich user experience beyond the unique functions of the robots by combining the functions of the respective robots through collaboration between the robots.

### BRIEF DESCRIPTION OF THE DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 illustrates a space and a situation in which embodiments of the present disclosure are implemented to adaptively establish an optimal service strategy for a robotic product connected to a network.

FIG. 2 illustrates a device configuration of the robotic product illustrated in FIG. 1.

FIG. 3 is a flowchart illustrating a cooperative control method of a multi-robot according to an embodiment of the present disclosure.

FIG. 4 illustrates configuration of a task proposed by embodiments of the present disclosure.

FIG. 5 illustrates configuration of an intention or a context candidate proposed by embodiments of the present disclosure.

FIG. 6 illustrates a process of selecting a task based on an intention or a context of FIG. 5.

FIG. 7 illustrates a connection structure between devices for implementing embodiments of the present disclosure.

FIG. 8 is a block diagram illustrating a cooperative control device of a multi-robot according to an embodiment of the present disclosure.

FIGS. 9A and 9B illustrate prototypes that implement a bookshelf and a chair which are robotic products performing a cooperative action.

FIG. 10 illustrates a scenario for performing a cooperative control of a multi-robot when a user is short.

FIGS. 11A to 11H illustrate examples of implementing, through a prototype, a scenario for performing a cooperative control of a multi-robot when a user is short.

FIG. 12 illustrates a scenario for performing a cooperative control of a multi-robot when a user is tall.

FIGS. 13A to 13H illustrate examples of implementing, through a prototype, a scenario for performing a cooperative control of a multi-robot when a user is tall.

### DETAILED DESCRIPTION

Reference will now be made in detail to embodiments of the disclosure, examples of which are illustrated in the accompanying drawings. Detailed descriptions of known arts will be omitted if such may mislead the gist of embodiments of the present disclosure. In addition, throughout the present disclosure, “comprising” a certain component means that other components may be further comprised, not that other components are excluded, unless otherwise stated.

Terms used in the present disclosure are only used to describe specific embodiments, and are not intended to limit the present disclosure. Expressions in the singular form include the meaning of the plural form unless they clearly mean otherwise in the context. In the present disclosure, expressions such as “comprise” or “have” are intended to mean that the described features, numbers, steps, operations, components, parts, or combinations thereof exist, and should not be understood to be intended to exclude in advance the presence or possibility of addition of one or more other features, numbers, steps, operations, components, parts, or combinations thereof.

Unless otherwise specified, all of the terms which are used herein, including the technical or scientific terms, have the same meanings as those that are generally understood by a person having ordinary skill in the art to which the present disclosure pertains. The terms defined in a generally used dictionary can be understood to have meanings identical to those used in the context of a related art, and are not to be construed to have ideal or excessively formal meanings unless they are obviously specified in the present disclosure.

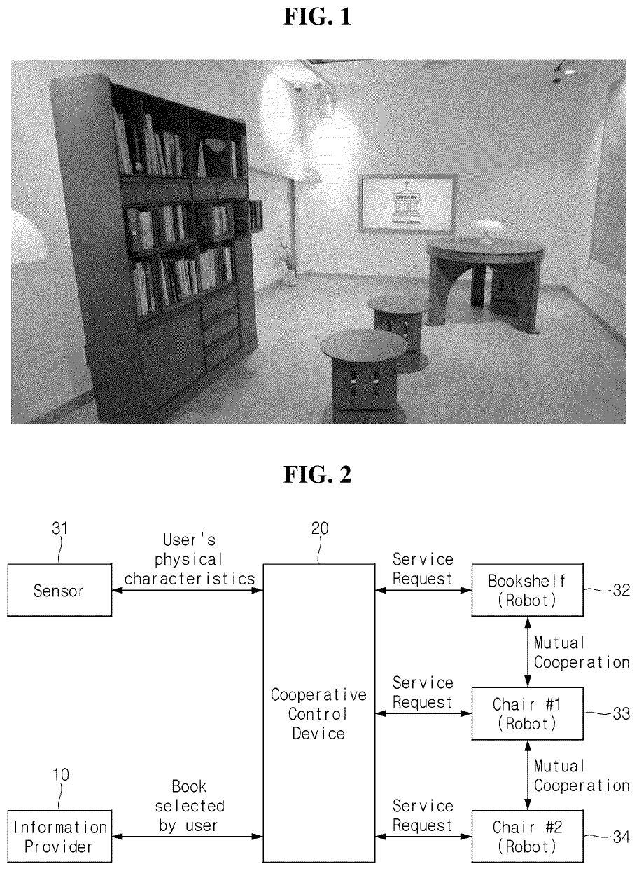

FIG. 1 illustrates a space and a situation in which embodiments of the present disclosure are implemented to adaptively establish an optimal service strategy for a robotic product connected to a network. Referring to the illustrated space, it is assumed that there are multiple homogeneous and heterogeneous robotic products, such as height measurement sensors (not shown), bookshelves, and chairs, in the space, and that these robotic products cooperate by exchanging information on a user and information on an environment.

To this end, the present disclosure aims to efficiently identify a user's intention by sharing information obtained by multiple homogeneous and heterogeneous robotic products connected to the same network, and to provide a user customized service suitable for a situational context through cooperation between robots. In addition, the present disclosure adaptively establishes an optimal service strategy as configuration of the robotic products connected to the network changes, and each robotic product aims to provide necessary services to the user by specializing/converting functions based on the situational context as well as the original function of the product. In the illustrated space, the bookshelf may open the drawer containing the book the user wants and provide the user with the book. In addition, the chair may be used as a tool suitable for a situation by moving based on the user's intention or a spatial context by including a self-moving driving means. For example, the chair may be used as a ladder to reach books on a high shelf in the bookshelf, as a cart to transport books, or as a chair for its original purpose.

FIG. 2 illustrates a device configuration of the robotic product illustrated in FIG. 1. Referring to FIG. 2, an information provider 10, a sensor 31, a bookshelf 32, chairs 33 and 34, etc. are provided centered around a cooperative control device 20.

The cooperative control device 20 communicates with multiple robotic products 31, 32, 33 and 34 and controls mutual cooperation with these robotic products. If necessary, the robotic products may be implemented as a separate device as illustrated in FIG. 2, or a specific robotic product may be granted master authority and may be set as a control subject. For example, a role of the cooperative control device 20 may be set to the bookshelf 32 of FIG. 2, and in this case, it may have a physically identical configuration.

The information provider 10 may provide book information selected by a user to the cooperative control device 20. The information provider 10 can be implemented in the form of a book application and may share the selection book information of the user with other robotic products through a wireless communication means such as Bluetooth. The book information includes bibliographic information of the book, a location of the book in the bookshelf, etc., thereby supporting the other robotic products to perform appropriate actions. For example, the bookshelf may open the drawer containing the selected book in advance or help the user easily take the book through other notification means.

The sensor 31 may collect physical characteristics of the user and provide them to the cooperative control device 20. For example, by implementing the height measurement sensor to be located at an entrance, the height of a user entering the space may be measured and shared with other robotic products, thereby inducing the provision of a service suitable for the physical characteristics of the user (height).

The bookshelf 32 may be a service robot that processes an action of appropriately taking out the contained books. For example, when the user selects a desired book, the drawer, in which the book is located, automatically opens, and when the user takes the book, the drawer automatically closes. Based on the information shared from the sensor 31 and the information provider 10, a service strategy for the user is established, and the chairs 33 and 34 are requested to provide the service.

The chairs 33 and 34 are a service robot that includes a self-moving driving means and automatically moves to a location suitable for the situation. The chairs 33 and 34 not only provides the original function of the chair, but also performs a service requested from the cooperative control device 20. To this end, the chairs 33 and 34 sometimes serve as a ladder, sometimes as a cart, and sometimes as a chair.

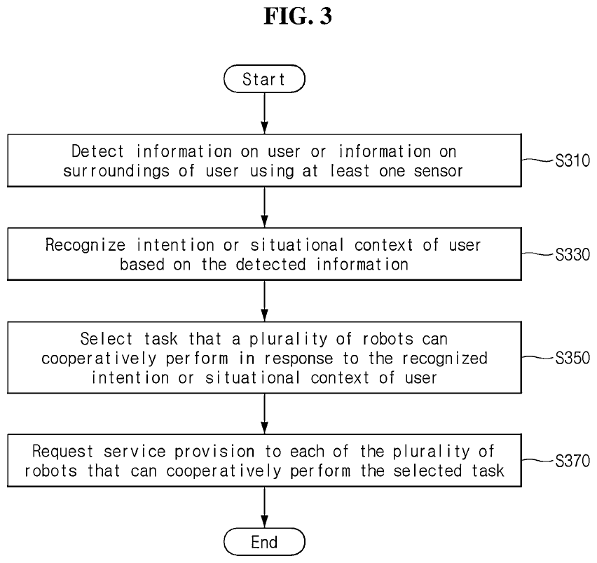

FIG. 3 is a flowchart illustrating a cooperative control method of a multi-robot according to an embodiment of the present disclosure. A control device including at least one processor may be implemented to process instructions to perform each step described below.

In step S310, the control device detects information on a user or information on surroundings of the user using at least one sensor. To this end, a height of the user may be measured using a height measurement sensor, and measured height information may be transmitted to the control device via robot operating system (ROS) communication. In addition, the control device may receive information on a book selected by the user through a book application and transmit data about a drawer containing the selected book to a bookshelf.

In step S330, the control device recognizes an intention or a situational context of the user based on the information detected through the step S310. The control device intends to identify the current user's intention or derive the situational context using various sensing information (e.g., user's body information, user's behavior information, environmental information, etc.) and additional input information (e.g., book selection information) within a given space to thereby infer necessary services.

In step S350, the control device selects a task that a plurality of robots can cooperatively perform in response to the intention or situational context of the user recognized through the step S330. If the intention or situational context of the user has been recognized, a task corresponding to it is required. In this instance, the task does not mean a simple function, but may include a series of actions necessary to achieve the purpose. In other words, a plurality of performers and a plurality of actions may be involved to achieve the task.

In step S370, the control device requests service provision to each of the plurality of robots that can cooperatively perform the task selected through the step S350. In this process, after selecting suitable robots to achieve the task, the robots are instructed to perform a suitable small-unit function, and thus the final service provision can be completed through cooperation between these robots. In this instance, the selected robots may include not only homogeneous robotic products but also heterogeneous robotic products, and flexible purpose beyond the product's own functions can be achieved possible through cooperation between the homogeneous and heterogeneous robotic products.

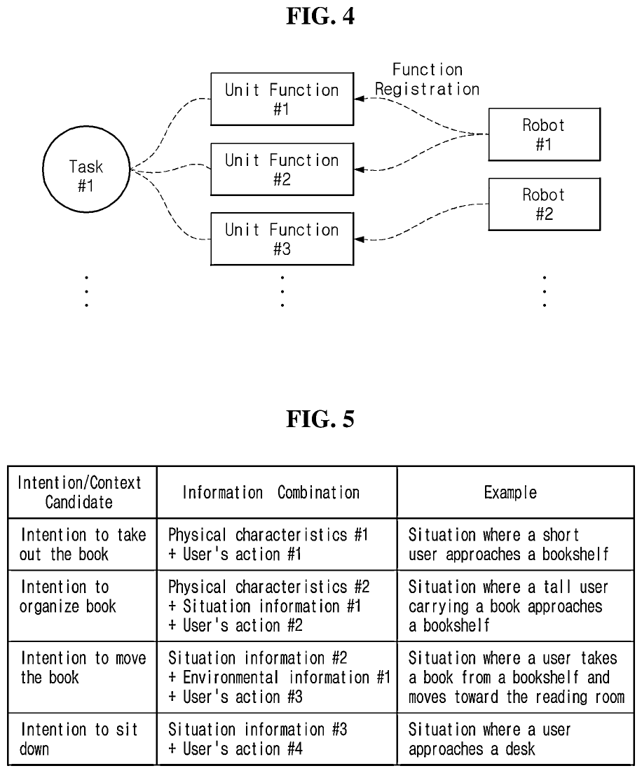

It is preferable that the control device registers at least one unit function that can be provided from each of the plurality of robots, and pre-generates a cooperative executable task of the plurality of robots from a combination of the registered unit functions before the step S350. FIG. 4 illustrates configuration of a task proposed by embodiments of the present disclosure. Referring to FIG. 4, unit functions provided from heterogeneous multi-robots can be registered, and tasks can be configured a combination of the registered unit functions.

Here, the unit function may be either a unique function corresponding to an action that a robot can perform, or a plurality of functions that can be applied as different roles depending on an intention or a situational context of the user for an action that a robot can perform. For example, the unit function may be the ‘open drawer’ function which is a unique function of a bookshelf, or the ‘sit’ function which is a unique function of a chair. In addition, although it is not the unique function of the chair, the unit function may be a ‘ladder’ function that helps the user reach a high position, or a ‘cart’ function for carrying multiple books.

A task may include a plurality of unit functions that process complex actions required to achieve a purpose, and each of the plurality of unit functions may be matched to a robot capable of providing the corresponding unit function. The order of action execution and a target of communication between a plurality of robots cooperating to achieve the purpose may be set. In cooperative control using multiple heterogeneous robotic products, it is not sufficient for each robot to perform only its own predetermined function, and it is necessary to perform actions designed in time series in cooperation with each other. Therefore, the robots control the task so that the task can be successfully completed, by sharing a processing situation of the unit function that is currently performed, a situation detected by itself, and environment information through communication between the robots.

FIG. 5 illustrates configuration of an intention or a context candidate proposed by embodiments of the present disclosure. More specifically, FIG. 5 illustrates four candidates and an information combination constituting each candidate.

In embodiments of the present disclosure, a process of recognizing the intention or situational context of the user may include a process of receiving additional information related to a prearranged behavior of the user, and a process of selecting the most similar candidate among candidates for the intention or situational context of the user based on the received additional information and the detected information. For example, if information on the physical characteristics of the user being short is input, and also the user's behavior of approaching the bookshelf is detected, an “intention to take out a book” that is closest to a current intention or context may be selected based on the combination of these.

In embodiments of the present disclosure, the process of selecting the most similar candidate among the multiple candidates requires a process of pre-configuring the multiple candidates with respect to the intention or situational context of the user based on at least two combinations of information on the user's physical characteristics, information on the user's surroundings, environmental information on a space where the user is located, and information related to the user's behavior. The candidates configured as above are presented as illustrated in FIG. 5. Then, a candidate with a highest degree of matching among the multiple candidates may be determined using the received additional information and the detected information. In this case, the matching can be achieved by selecting the candidate with the highest degree of similarity in the combination of information.

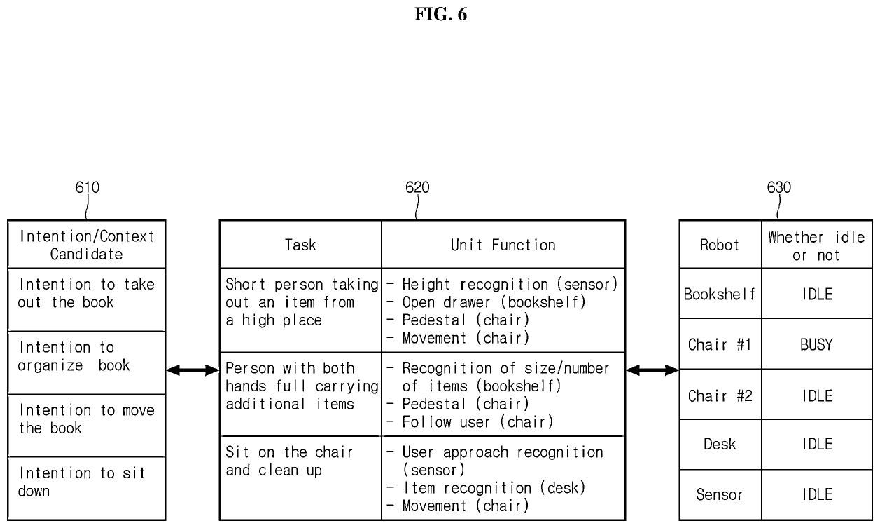

FIG. 6 illustrates a process of selecting a task 620 based on an intention or a context 610 of FIG. 5. A process of checking the availability of the multi-robot may be involved depending on the implementation needs, and a table 630 indicating the validity of the robot is referenced for this purpose.

In embodiments of the present disclosure, a process of selecting a task may include selecting a top priority task corresponding to the recognized intention or situational context of the user and checking whether a robot for cooperatively performing the top priority task is in an idle state. Then, if the robot for cooperatively performing the top priority task is not in the idle state, the process may select a next priority task corresponding to the recognized intention or situational context of the user and in which a robot for cooperatively performing the next priority task is in the idle state. It is obvious that the process can wait until the occupation of the robot, that is not in the idle state, ends and switches to the idle state.

Each item of the intention/context candidate 610 and the task 620 may be matched with a many-to-many relationship, and the matching relationship must be preset. For example, there may be at least one task corresponding to an “intention to move a book”, and the task may include “a short person taking out an item from a high place” as illustrated in FIG. 6. Although not illustrated in FIG. 6, the task may also include “a tall person taking out an item.” In addition, if the intention/context candidate 610 and the task 620 are multi-matched, priorities may be assigned based on preset rules. The priorities may be assigned a relatively high/low ranking depending on the degree of matching of the required unit functions, and the relative ranking may be assigned depending on whether an individual robot for the task is idle.

The unit functions for each task 620 illustrated in FIG. 6 are described in detail as follows.

First, for the task “a short person taking out an item from a high place,” a unit function is required where the chair communicates with the bookshelf and “moves” to a location where the book is located.

Second, for a task “a person with both hands full carrying additional items,” a unit function is required where the bookshelf ‘recognizes’ the size or number of items taken from the bookshelf. The bookshelf may recognize which items the user has taken from among items in a storage unit and determine whether the user can use his or her hands freely. In addition, a unit function is required where the chair approaches the user and “follows” the user when a predetermined number or a predetermined size of items are taken out of the storage unit.

Third, for a task “a person sitting on a chair and cleaning up,” a unit function is required where the chair ‘moves’ to perform the original function of the chair. For example, when the user tries to sit down on the chair, the chair requires a movement function that moves slightly back from the desk; when the user leaves the desk for a while, the desk needs to recognize the items on the desk and maintain the state; and when the user completely leaves the desk (when there is no item on the desk and the user has left the desk), the chair is required to be stored again under the desk and organize the chair space.

Accordingly, in embodiments of the present disclosure, the process of requesting the service provision may include a process of identifying a plurality of unit functions matched to the selected task and instructing each of the plurality of robots capable of performing the identified unit functions to mutually perform the corresponding unit functions in time series. Furthermore, the process of requesting the service provision may achieve more sophisticated interaction and operation performance through a process of controlling the exchange of information about the execution order and execution process between the robots.

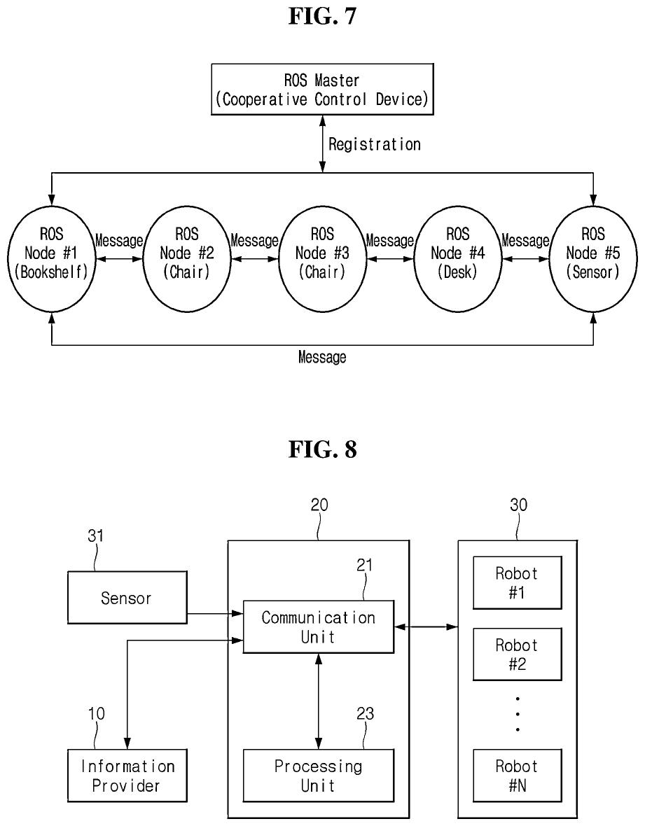

FIG. 7 illustrates a connection structure between devices for implementing embodiments of the present disclosure. More specifically, FIG. 7 illustrates a robot operating system (ROS) which is an example of an implementation means that provides hardware abstraction, lower-level device control, implementation of commonly used functions, message passing between processes, package management, libraries required for the development environment, and various development and debugging tools required when developing robot applications. The ROS is a robot platform such as an operating system for robot application development and includes a hardware platform as the hardware abstraction. The ROS is a software platform for supporting robot application software development and has functions such as an operating system that can be used on heterogeneous hardware.

Referring to FIG. 7, the cooperative control device may be set as a ROS master and may grasp available robot resources and functions that can be provided, by registering various ROS nodes. The ROS nodes may include various sensors, in addition to various robotic products such as the bookshelf, the chair, and the desk as described above. The ROS nodes may exchange messages through communication between the ROS nodes to thereby recognize states of the ROS nodes and requirements.

FIG. 8 is a block diagram illustrating the cooperative control device 20 of a multi-robot according to an embodiment of the present disclosure. More specifically, FIG. 8 illustrates a reconstruction of the cooperative control method of FIG. 3 described from a perspective of a time-series processing flow, from a perspective of hardware configuration. Therefore, only the function and operation of each component are briefly described here to avoid duplication of explanation.

The cooperative control device 20 of the multi-robot includes a communication unit 21 that receives information on a user or information on surroundings of the user detected using at least one sensor 31, and a processing unit 23 executing instructions that control a plurality of robots 30 to provide a service necessary for the user. More specifically, the processing unit 23 may execute instructions that recognize an intention or a situational context of the user based on the detected information, select a task that the plurality of robots 30 can cooperatively perform in response to the recognized intention or situational context of the user, and request a service provision to each of the plurality of robots 30 that can cooperatively perform the selected task.

The processing unit 23 may further execute instructions that register at least one unit function that can be provided from each of the plurality of robots 30 and pre-generate a cooperative executable task of the plurality of robots from a combination of the registered unit functions. Here, the unit function may be either a unique function corresponding to an action that a robot can perform, or a plurality of functions that can be applied as different roles depending on an intention or a situational context of the user for an action that a robot can perform. The task may include a plurality of unit functions that process complex actions required to achieve a purpose, and each of the plurality of unit functions may be matched to a robot capable of providing the corresponding unit function. The order of action execution and a target of communication between a plurality of robots cooperating to achieve the purpose may be set.

The processing unit 23 may execute instructions that receive additional information related to a prearranged behavior of the user, and select the most similar candidate among candidates for the intention or situational context of the user based on the received additional information and the detected information. Hence, the processing unit 23 can recognize the intention or situational context of the user. The processing unit 23 may execute instructions that pre-configure multiple candidates with respect to the intention or situational context of the user based on at least two combinations of information on physical characteristics of the user, information on the user's surroundings, environmental information on a space where the user is located, and information related to a behavior of the user, and determine a candidate with a highest degree of matching among the multiple candidates using the received additional information and the detected information. Hence, the processing unit 23 can select the most similar candidate among the candidates.

The processing unit 23 may execute instructions that select a top priority task corresponding to the recognized intention or situational context of the user, check whether a robot for cooperatively performing the top priority task is in an idle state, and if the robot for cooperatively performing the top priority task is not in the idle state, select a next priority task corresponding to the recognized intention or situational context of the user and in which a robot for cooperatively performing the next priority task is in the idle state. Hence, the processing unit 23 can select the task.

The processing unit 23 may execute instructions that identify a plurality of unit functions matched to the selected task and instruct each of the plurality of robots capable of performing the identified unit functions to mutually perform the corresponding unit functions in time series. Hence, the processing unit 23 can request the service provision. The processing unit 23 may further execute instructions that control the exchange of information about the execution order and execution process between the robots when requesting the service provision.

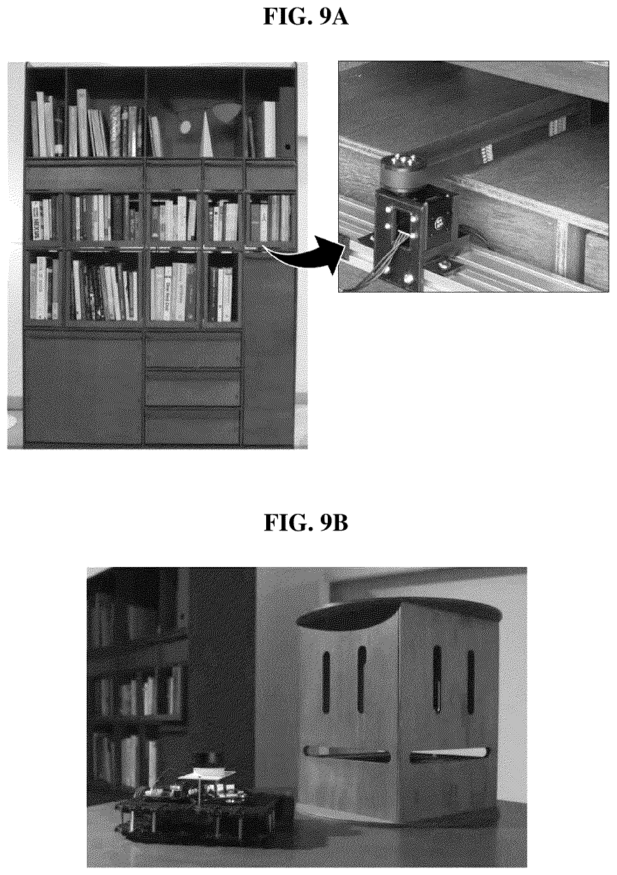

FIGS. 9A and 9B illustrate prototypes that implement a bookshelf and a chair which are robotic products performing a cooperative action.

Referring to FIG. 9A, if a bookshelf receives information on a book selected by a user from a book application based on wireless communication such as Bluetooth, the bookshelf opens a drawer containing the book selected by the user using a drive means (motor and belt) built into the bookshelf. Then, if the user takes the book, the bookshelf recognizes the book being taken out and automatically closes the drawer. In this process, the bookshelf combines body information of the user (height), information on the book selected by the user, and the open/close information of the drawer and provides the combined information to a chair via ROS communication to thereby instruct the chair to move.

Referring to FIG. 9B, the chair includes a communication means for receiving a movement command from a cooperative control device and a drive means for moving itself, and may optionally include a sensor for recognizing the approach of an object. When the user approaches a desk, the chair serves as a ‘chair’ and moves slightly back to make it easier for the user to sit down. Depending on a situation, the chair serves as a ‘cart’ and moves to a position next to the bookshelf so that the user can use the chair as a cart for carrying items. Depending on the situation, the chair serves as a ‘ladder’ and moves to the front of the bookshelf where the book is located so that the user can step on the chair and take out the book.

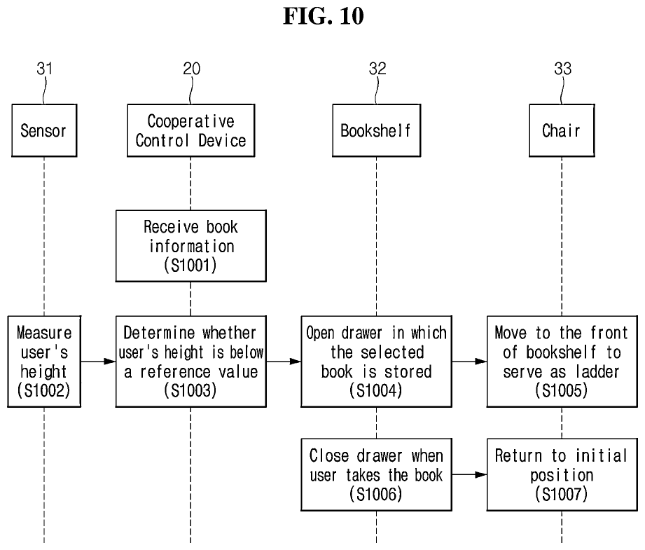

FIG. 10 illustrates a scenario for performing a cooperative control of a multi-robot when a user is short. More specifically, FIG. 10 illustrates a sequential control operation of a cooperative control device 20 interacting with a sensor 31, a bookshelf 32, and a chair 33. First, the cooperative control device 20 receives book information from an information provider (not shown), such as a book application, in S1001. In addition, the cooperative control device 20 receives height information of a user measured by the sensor 31 in S1002 and determines whether the user's height is below a reference value in S1003. If the user's height is below the reference value, the cooperative control device 20 determines that it is difficult for the user to take out a book from the bookshelf 32 on his or her own and requests help from the chair 33. To this end, the bookshelf 32 opens a drawer containing the selected book in S1004, and the chair 33 moves to the front of the bookshelf 32 to serve as a ladder in S1005. Then, when the user takes the book, the bookshelf 32 closes the drawer in S1006, and the chair 33, which has completed its role, returns to an initial position in S1007.

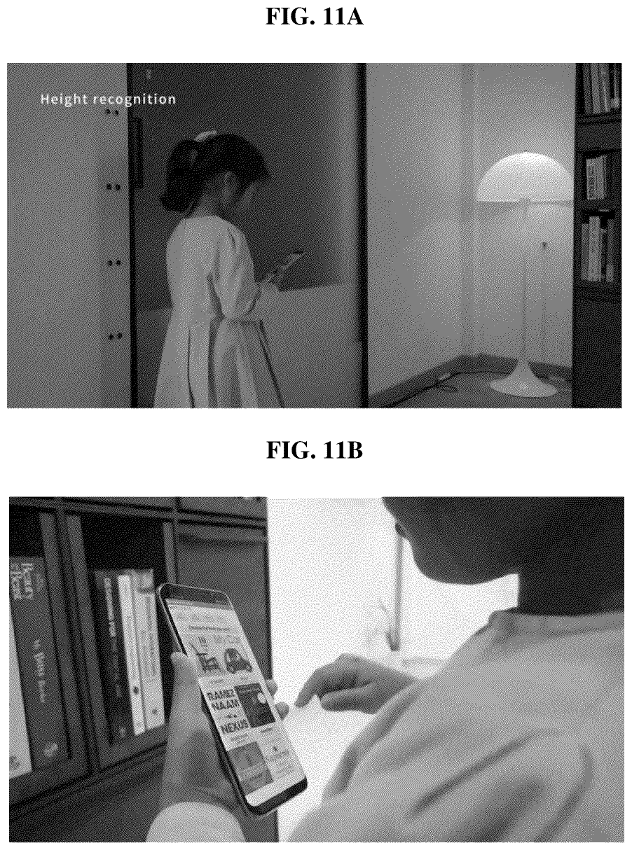

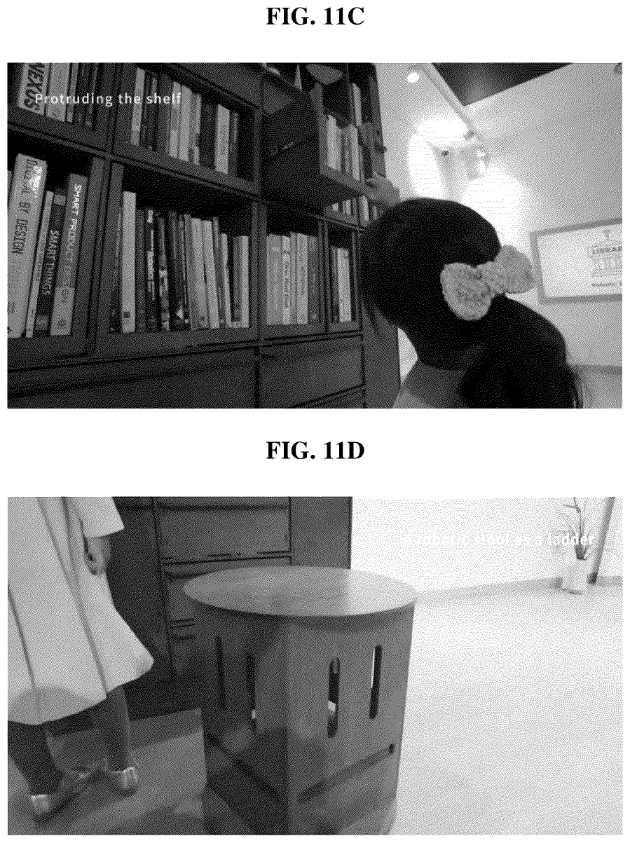

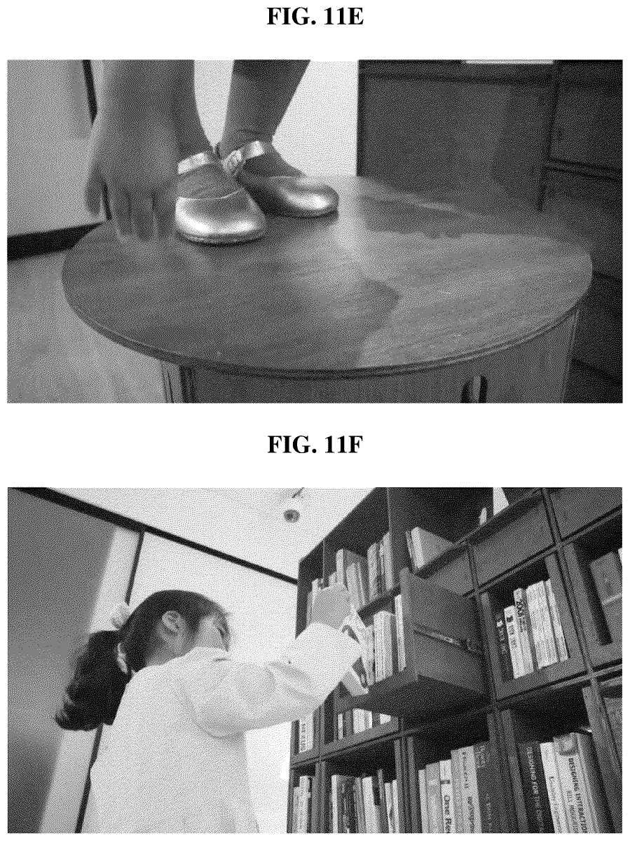

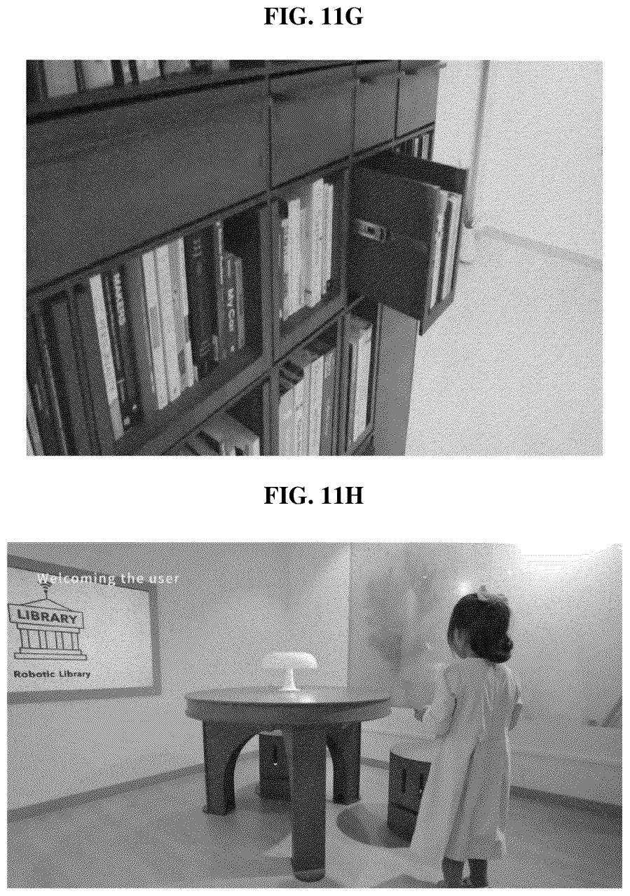

FIGS. 11A to 11H illustrate examples of implementing, through a prototype, a scenario for performing a cooperative control of a multi-robot when a user is short. In FIG. 11A, a height measurement sensor measures a height of a user and detects that the user's height is below a reference value. In FIG. 11B, a desired book is selected from the user through a book application, and information on the selected book is transmitted via Bluetooth communication, etc. In FIG. 11C, a bookshelf opens a drawer containing the book selected by the user. In this instance, the user is short and cannot reach the drawer with his or her arm. In FIG. 11D, a cooperative control device determines that the user needs help and moves a chair in front of the bookshelf to help the user. In FIG. 11E, the user steps on the chair and can then take out the book, as illustrated in FIG. 11F. In FIG. 11G, the bookshelf recognizes that the user has taken the book and automatically closes the drawer. In FIG. 11H, the chair that has finished its role as a ladder returns to its initial position.

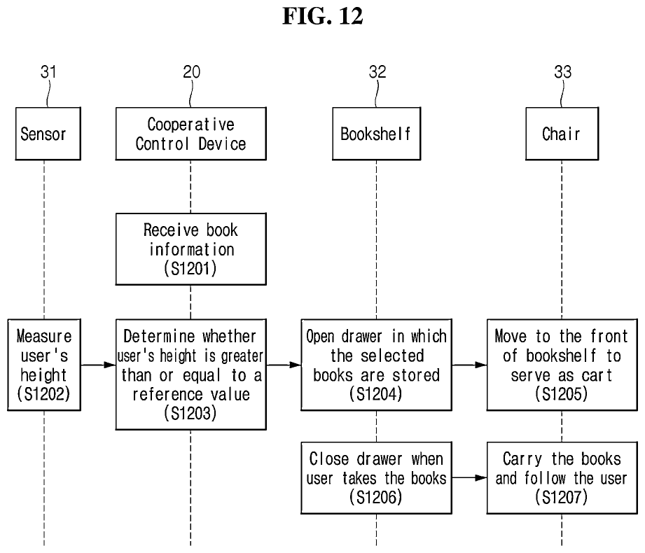

FIG. 12 illustrates a scenario for performing a cooperative control of a multi-robot when a user is tall. More specifically, FIG. 12 illustrates a sequential control operation of a cooperative control device 20 interacting with a sensor 31, a bookshelf 32, and a chair 33. First, the cooperative control device 20 receives book information from an information provider (not shown), such as a book application, in S1201. In this instance, assume a situation where a user has selected multiple books. In addition, the cooperative control device 20 receives height information of the user measured by the sensor 31 in S1202 and determines whether the user's height is greater than or equal to a reference value in S1203. If the user's height is greater than or equal to the reference value, the cooperative control device 20 may determine that the user can take the books out of the bookshelf 32 on his or her own, but may request help from the chair 33 considering that the user has selected the multiple books. To this end, the bookshelf 32 opens a drawer containing the selected books in S1204, and the chair 33 moves to the front of the bookshelf 32 to serve as a cart in S1205. Then, when the user takes the book, the bookshelf 32 closes the drawer in S1206, and the chair 33 can carry the multiple books and follow the user to move to a specific location in S1207.

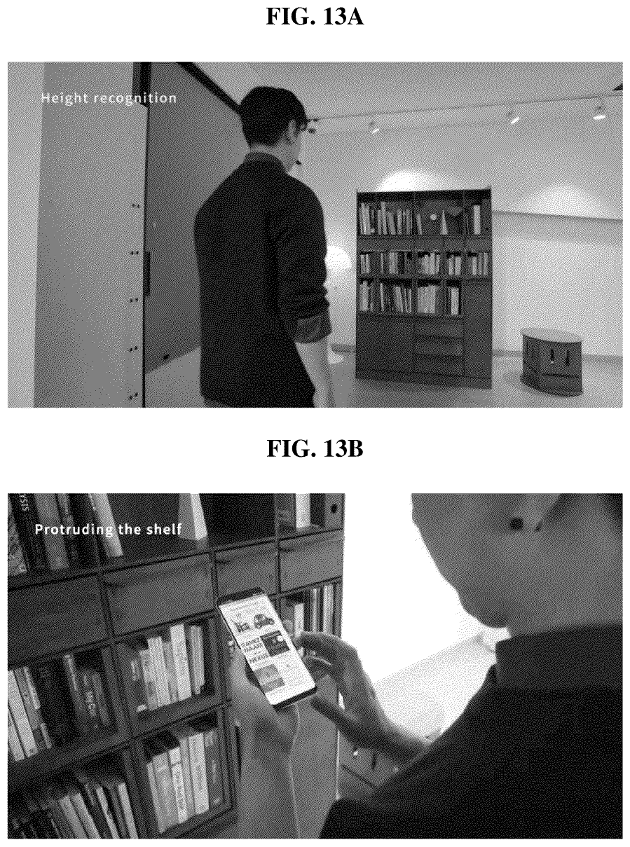

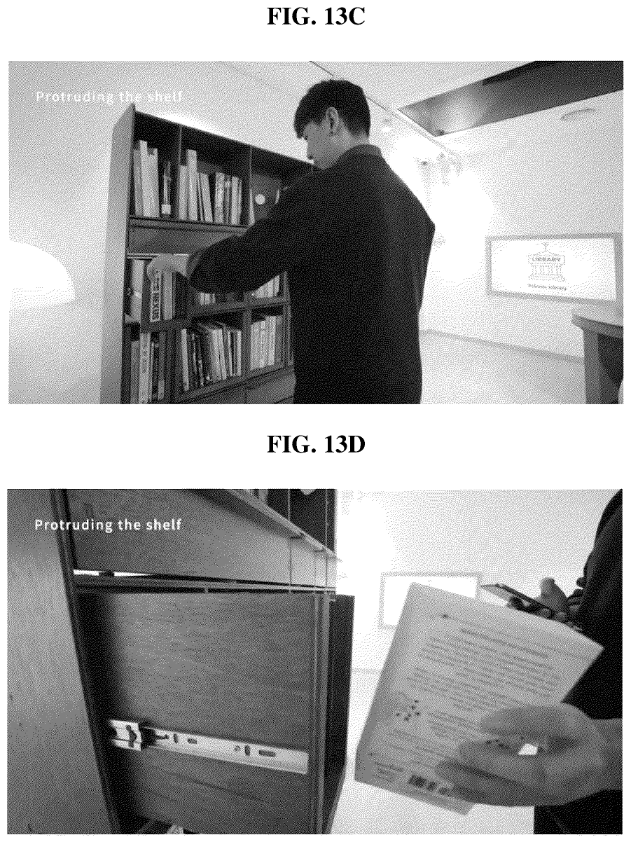

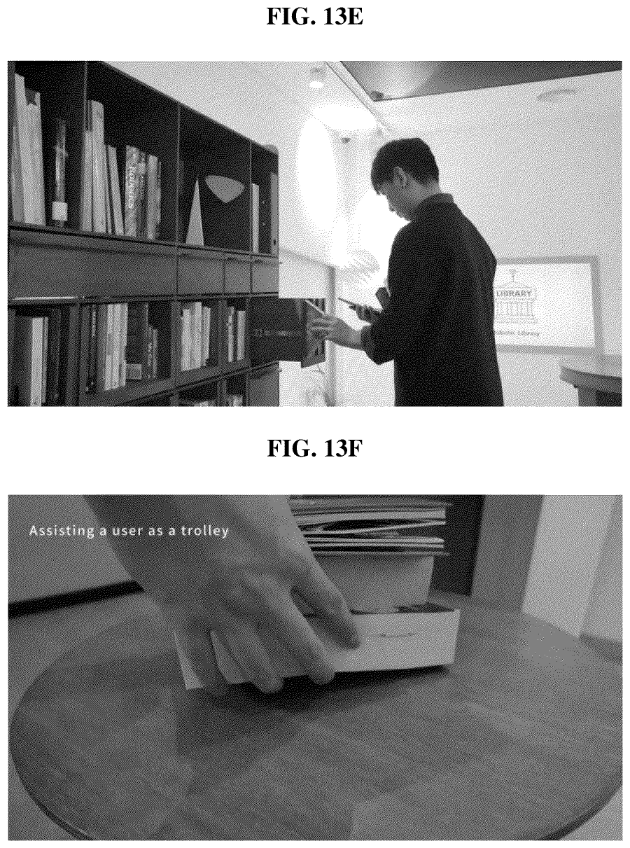

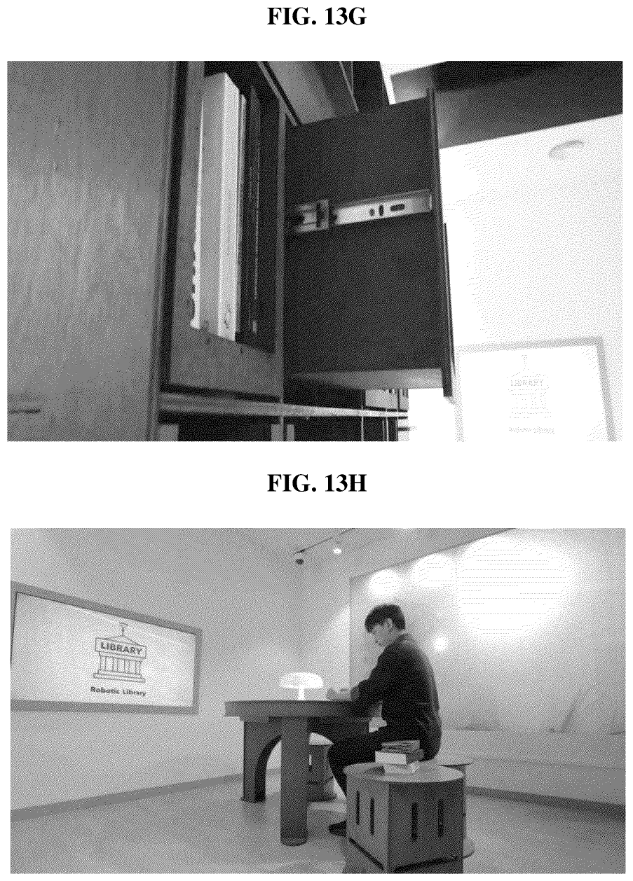

FIGS. 13A to 13H illustrate examples of implementing, through a prototype, a scenario for performing a cooperative control of a multi-robot when a user is tall. In FIG. 13A, a height measurement sensor measures a height of a user and detects that the user's height is greater than or equal to a reference value. In FIG. 13B, a desired book is selected from the user through a book application, and information on the selected book is transmitted via Bluetooth communication, etc. In this instance, a situation is presented where the user has selected multiple books. In FIG. 13C, the bookshelf sequentially opens drawers containing the multiple books selected by the user. In this instance, as illustrated in FIG. 13D, the user is tall enough to take out the books directly from the drawers. However, in FIG. 13E, the cooperative control device recognizes that the user has selected the multiple books and determines that the user needs help. In FIG. 13F, a chair moves next to the bookshelf to help the user, and the user can use the chair as a cart. In FIG. 13G, the bookshelf recognizes that the user has taken the books and automatically closes the drawers. In FIG. 13H, when the drawer that has contained the books selected by the user is finally closed, the chair moves next to the position where the user will sit with the multiple books loaded on the chair. When the chair arrives, another chair located under the desk moves slightly out of the desk to make it easier for the user to sit.

Embodiments of the present disclosure can facilitate information utilization by acquiring a variety of information from multiple homogeneous and heterogeneous robotic products, can more specifically identify the user's intention and more efficiently recognize the situational context by sharing user information and environment information through communication between robots, and can provide optimal user service and a rich user experience beyond the unique functions of the robots by combining the functions of the respective robots through collaboration between the robots.

Embodiments of the present disclosure can be implemented by various means, for example, hardware, firmware, software, or combinations thereof. When embodiments are implemented by hardware, one embodiment of the present disclosure can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like. When embodiments are implemented by firmware or software, one embodiment of the present disclosure can be implemented by modules, procedures, functions, etc. performing functions or operations described above. Software code can be stored in a memory and can be driven by a processor. The memory is provided inside or outside the processor and can exchange data with the processor by various well-known means.

Embodiments of the present disclosure can be implemented as computer-readable codes on a computer-readable recording medium. The computer-readable recording medium includes all types of recording devices in which data readable by a computer system is stored. Examples of the computer-readable recording medium include a ROM, a RAM, a CD-ROM, a magnetic tape, a floppy disk, an optical data storage device, etc. Further, the computer-readable recording medium may be distributed to computer systems connected over a network, and computer-readable codes may be stored and executed in a distributed manner. Functional programs, codes, and code segments for implementing embodiments of the present disclosure can be easily construed by programmers skilled in the art to which the present disclosure pertains.

In summary, in one or more non-transitory computer readable mediums storing one or more instructions, the one or more instructions executable by one or more processors may comprise receiving information on a user or information on surroundings of the user detected using at least one sensor, recognizing an intention or a situational context of the user based on the detected information, selecting a task that a plurality of robots are able to cooperatively perform in response to the recognized intention or situational context of the user, and requesting a service provision to each of the plurality of robots that are able to cooperatively perform the selected task.

As described above, the present disclosure has been examined focusing on its various embodiments. A person with ordinary skills in the technical field to which the present disclosure pertains will be able to understand that the various embodiments can be implemented in modified forms within the scope of the essential characteristics of the present disclosure. Therefore, the disclosed embodiments are to be considered illustrative rather than restrictive. The scope of the present disclosure is shown in the claims rather than the foregoing description, and all differences within the scope should be construed as being included in the present disclosure.

What is claimed is:

1. A cooperation control method of a multi-robot performed by a control device, the method comprising:
detecting information on a user or information on surroundings of the user using at least one sensor;
recognizing an intention or a situational context of the user based on the detected information;
selecting a task that a plurality of robots are able to cooperatively perform in response to the recognized intention or situational context of the user; and
requesting a service provision to each of the plurality of robots that are able to cooperatively perform the selected task.

2. The cooperation control method of the multi-robot of claim 1, further comprising:
registering at least one unit function that is able to be provided from each of the plurality of robots and pre-generating a cooperative executable task of the plurality of robots from a combination of the registered unit functions.

3. The cooperation control method of the multi-robot of claim 2, wherein the unit function is either a unique function corresponding to an action that a robot is able to perform, or a plurality of functions that are able to be applied as different roles depending on the intention or situational context of the user for an action that a robot is able to perform.

4. The cooperation control method of the multi-robot of claim 2, wherein the task includes a plurality of unit functions that process a complex action required to achieve a purpose,
wherein each of the plurality of unit functions is matched to a robot capable of providing the corresponding unit function, and
wherein an order of action execution and a target of communication between the plurality of robots cooperating to achieve the purpose are set.

5. The cooperation control method of the multi-robot of claim 1, wherein recognizing the intention or situational context of the user comprises:
receiving additional information related to a prearranged behavior of the user; and
selecting a most similar candidate among candidates for the intention or situational context of the user based on the received additional information and the detected information.

6. The cooperation control method of the multi-robot of claim 5, wherein selecting the most similar candidate comprises:
pre-configuring multiple candidates with respect to the intention or situational context of the user based on at least two combinations of information on physical characteristics of the user, the information on the surroundings of the user, environmental information on a space where the user is located, and information related to a behavior of the user; and
determining a candidate with a highest degree of matching among the multiple candidates using the received additional information and the detected information.

7. The cooperation control method of the multi-robot of claim 1, wherein selecting the task comprises:
selecting a top priority task corresponding to the recognized intention or situational context of the user and checking whether a robot for cooperatively performing the top priority task is in an idle state; and
when the robot for cooperatively performing the top priority task is not in the idle state, selecting a next priority task corresponding to the recognized intention or situational context of the user and in which a robot for cooperatively performing the next priority task is in the idle state.

8. The cooperation control method of the multi-robot of claim 1, wherein requesting the service provision comprises:
identifying a plurality of unit functions matched to the selected task; and
instructing each of the plurality of robots capable of performing the identified unit functions to mutually perform the corresponding unit function in time series.

9. The cooperation control method of the multi-robot of claim 8, wherein requesting the service provision further comprises:
controlling an exchange of information on an execution order and an execution process between the robots.

10. One or more non-transitory computer readable mediums storing one or more instructions,
wherein the one or more instructions executable by one or more processors comprise:
receiving information on a user or information on surroundings of the user detected using at least one sensor;
recognizing an intention or a situational context of the user based on the detected information;
selecting a task that a plurality of robots are able to cooperatively perform in response to the recognized intention or situational context of the user; and
requesting a service provision to each of the plurality of robots that are able to cooperatively perform the selected task.

11. A cooperative control device of a multi-robot comprising:
a communication unit configured to receive information on a user or information on surroundings of the user detected using at least one sensor; and
a processing unit configured to execute instructions that control a plurality of robots to provide a service necessary for the user,
wherein the processing unit is further configured to execute instructions that recognize an intention or a situational context of the user based on the detected information, select a task that the plurality of robots are able to cooperatively perform in response to the recognized intention or situational context of the user, and request a service provision to each of the plurality of robots that are able to cooperatively perform the selected task.

12. The cooperative control device of the multi-robot of claim 11, wherein the processing unit further executes instructions that register at least one unit function that is able to be provided from each of the plurality of robots and pre-generate a cooperative executable task of the plurality of robots from a combination of the registered unit functions.

13. The cooperative control device of the multi-robot of claim 12, wherein the unit function is either a unique function corresponding to an action that a robot is able to perform, or a plurality of functions that are able to be applied as different roles depending on the intention or situational context of the user for an action that a robot is able to perform.

14. The cooperative control device of the multi-robot of claim 12, wherein the task includes a plurality of unit functions that process a complex action required to achieve a purpose,
wherein each of the plurality of unit functions is matched to a robot capable of providing the corresponding unit function, and
wherein an order of action execution and a target of communication between the plurality of robots cooperating to achieve the purpose are set.

15. The cooperative control device of the multi-robot of claim 11, wherein the processing unit recognizes the intention or situational context of the user by executing instructions that receive additional information related to a prearranged behavior of the user and select a most similar candidate among candidates for the intention or situational context of the user based on the received additional information and the detected information.

16. The cooperative control device of the multi-robot of claim 15, wherein the processing unit selects the most similar candidate among the candidates by executing instructions that pre-configure multiple candidates with respect to the intention or situational context of the user based on at least two combinations of information on physical characteristics of the user, the information on the surroundings of the user, environmental information on a space where the user is located, and information related to a behavior of the user, and determine a candidate with a highest degree of matching among the multiple candidates using the received additional information and the detected information.

17. The cooperative control device of the multi-robot of claim 11, wherein the processing unit selects the task by executing instructions that select a top priority task corresponding to the recognized intention or situational context of the user, check whether a robot for cooperatively performing the top priority task is in an idle state, and, when the robot for cooperatively performing the top priority task is not in the idle state, select a next priority task corresponding to the recognized intention or situational context of the user and in which a robot for cooperatively performing the next priority task is in the idle state.

18. The cooperative control device of the multi-robot of claim 11, wherein the processing unit requests the service provision by executing instructions that identify a plurality of unit functions matched to the selected task, and instruct each of the plurality of robots capable of performing the identified unit functions to mutually perform the corresponding unit function in time series.

19. The cooperative control device of the multi-robot of claim 18, wherein the processing unit further executes instructions that control an exchange of information on an execution order and an execution process between the robots when requesting the service provision.
